(19) United States
(12) Patent Application Publication
(10) Pub. No.: US 2014/0248585 A1
(43) Pub. Date: Sep. 4, 2014

(54) MEDICAL BARRIER WITH MICRO PORES

(71) Applicant: Shih-Liang Stanley Yang, Laguna Hills, CA (US)

(72) Inventor: Shih-Liang Stanley Yang, Laguna Hills, CA (US)

(21) Appl. No.: 14/194,722

(22) Filed: Mar. 1, 2014

Related U.S. Application Data
(60) Provisional application No. 61/771,605, filed on Mar. 1, 2013.

(51) Int. Cl. A61C 8/02

(52) U.S. Cl. CPC A61C 8/0006
USPC 433/215

(57) ABSTRACT

A medical barrier made by micro porous expanded polytetrafluoroethylene (ePTFE) is disclosed. The medical barrier allows the attachment and ingrowth of cells and tissue to within one, two or several cellular length, but not across the sheet material, and the tissue can still be pulled or peeled apart from the micro porous sheet with non-surgical and non-traumatic procedures. This medical barrier of the present invention is particularly useful in guided tissue regeneration in the repair of bone defects, as for example in the repair of alveolar bone defects. The medical barrier prevents the entry of rapidly migrating gingival tissue cells into the defect and allows the alveolar bone to regenerate.

### CROSS-REFERENCE TO RELATED APPLICATIONS

This application claims priority under 35 U.S.C. §119 (e) to U.S. Provisional Patent Application Ser. No. 61/771,605, filed on Mar. 1, 2013, the entire contents of which are hereby incorporated by reference.

### FIELD OF THE INVENTION

The present invention relates generally to implantable medical products made of expanded polytetrafluoroethylene (ePTFE) material, and more particularly to an expanded polytetrafluoroethylene (ePTFE) medical barrier that facilitates cell and tissue attachment, but limits its penetration to one, two, to several cellular layer from the surface level. Such material is particularly well adapted for use in medical applications that requires non-traumatic, non-surgical removal of the ePTFE membranes after wound healing or tissue regeneration is completed.

### BACKGROUND OF THE INVENTION

Regeneration of bone defects remains a significant clinical problem in oral reconstructive surgery. Bone defects may occur as a result of tooth extraction, cyst formation, surgery, trauma, or destruction by periodontal or peri-implant disease. Several synthetic membrane materials have been used for guided tissue regeneration, including cellulose acetate filter, perforated Teflon® mantle leaf, expanded polytetrafluoroethylene (PTFE), and resorbable polymers. Naturally derived membranes such as bovine collagen and lyophilized dura mater have also been used.

Membrane-assisted guided tissue regeneration techniques are based on the hypothesis that during wound healing, cells adjacent to the bone defect migrate to repopulate the defect at various rates. By placing a barrier such as a biocompatible membrane over the defect, the rapidly migrating connective tissue cells will be mechanically prevented from entering the defect. Theoretically, this allows the slower-migrating mesenchymal cells from the surrounding bone and marrow, having osteogenic potential, to repopulate the defect selectively. A common feature of earlier synthetic membrane systems is macro porosity, which was believed to enhance regeneration by improving wound stability through tissue integration and allowing diffusion of extra-cellular nutrients across the membrane. However, the use of macro porous biomaterials in the oral cavity may result in early bacterial contamination of the material. Bacterial contamination of macro porous biomaterials may result in antibiotic-resistant infection, which may lead to early removal of the biomaterial.

Additionally, a common feature of macro porous biomaterials is the ingrowth of surrounding tissues, which was considered necessary for stabilization of the implant. In macro porous biomaterials, cells readily incorporate into the material and connective tissue is manufactured. While this incorporation into the material slows the migration of cells, it presents a difficult problem to the patient and the surgeon during the removal process. The incorporated cells and fibrous connective material may make removal of the barrier painful and traumatic to the patient, and very time-consuming and difficult for the surgeon.

Recently, it has been discovered that the use of a flexible high-density polytetrafluoroethylene (PTFE) sheet material is useful in guided tissue regeneration. High density PTFE is substantially nonporous, so it would not incorporate with cells or attach to fibrous adhesions. By presenting a smooth surface to the biological materials, a high density PTFE barrier is easily inserted and removed following extended implantation periods. An example of a high density PTFE barrier material is disclosed in U.S. Pat. No. 5,480,711. While high density PTFE medical barriers provide advantages over macro porous barriers, the smooth surface of the high density PTFE barriers sometimes leads to dehiscence of the soft tissue overlying the barrier. The dehiscence problem is caused by the fact that the smooth surface of high density PTFE will not incorporate cells and will not attach to fibrous adhesions. Thus, over the course of healing, the incision will occasionally split open over the high density PTFE barrier.

U.S. Pat. No. 5,957,690 discloses the use of high density PTFE membrane with plurality of indentations on the surface to improve the adherence of gingival tissue to the textured surface of the barrier to anchor the gingival tissue over the barrier, thereby preventing dehiscence or splitting open of the tissue covering the material. While high density PTFE barriers with plurality of discrete indentations improve the adherence of gingival tissue to the barrier membrane, dehiscence or early exposure of the tissue covering the material still occurs. Tissue dehiscence or early exposure of the soft tissue may result in contamination and infection of the wound site resulting in partial or complete failure of the intended surgical procedure. In addition, the non-porous, impenetrable nature of high density PTFE membranes that restrict the diffusions of nutrients to the gingival tissue overlying the PTFE membrane also contribute the dehiscence and early exposure of the high density PTFE membrane. Therefore, there remains a need for a new and improved medical barrier to overcome the abovementioned problems.

### SUMMARY OF THE INVENTION

The present invention provides a medical barrier that includes a sheet of micro porous, expanded polytetrafluoroethylene (ePTFE) polymer material having a density in a range of about 0.3 gm/cc to about 1.2 gm/cc, and preferably in the range of about 0.4 gm/cc to about 1.0 gm/cc. Preferably, the sheet has at least one textured surface, and has substantially the needed strength required for the applications in all directions. The sheet of medical barrier of the present invention has a thickness in a range of about 0.01 mm to about 1.00 mm, preferably in the range of about 0.05 mm to about 0.50 mm, and more preferably in the range of about 0.1 mm to about 0.3 mm. The textured surface may include a continuous dotted pattern of holes, and preferably a continuous woven pattern or a continuous pattern of hills and valley formed in the surface of the sheet. If the sheet has only one textured surface, the valley or the indentations have a depth less than the thickness of the sheet and each valley or indentation has a width of less than 0.5 mm, and preferably less than 0.3 mm. The textured patterns are distributed substantially uniform over the surface of the sheet. If the sheet has textured pattern on both surfaces, the valley or the indentations have a depth less than the half the thickness of the sheet. The textured pattern is repeated at less than 500 microns, preferably less than 200 microns and more preferably at less than 100 microns are distributed uniformly over the surface of the sheet.

In addition, the sheet of the ePTFE medical barrier of the present invention is micro porous and has a porosity selected from the following ranges: (A) from about 5% to about 20%, (B) from about 20% to about 40%, (C) from about 40% to about 60%, and (D) more than 60%. Preferably, the ePTFE membrane has a density of less than 1 g/cc, and has an average fibril length selected from the following ranges: (A) less than 60 microns, (B) less than 30 microns, (C) less than 15 microns, and (D) less than 10 microns

The medical barrier of the present invention is particularly well adapted for guided tissue regeneration to repair bone defects, and more particularly to repair alveolar bone defects. The barrier prevents rapidly migrating gingival tissue cells from entering into the defect and allows the alveolar bone to regenerate. During healing, the gingival tissue adheres to the textured surface of the micro porous barrier to anchor the gingival tissue over the barrier, thereby preventing dehiscence or splitting open of the tissue covering the material. However, the textured micro porous ePTFE medical barrier of the present invention prevents gingival tissue from growing substantially into or through the barrier. Thus, after the bone defect has healed, the barrier may be removed with a minimum of trauma to the gingival tissue.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

The present invention in part provides a method of repairing a defect in alveolar bone underlying gingival tissue, which comprises steps of: (a) placing a sheet of textured, micro porous ePTFE material having a density in a range of about 1.0 gm/cc to about 0.3 gm/cc, over said defect between the bone and the gingival tissue with said textured surface in contact with said gingival tissue; (b) securing the gingival tissue over the sheet, allowing the defect to heal under the sheet; and (c) removing the sheet after the defect has healed.

The micro porous ePTFE membrane may be secured in a place by the use of a biocompatible adhesive, and preferably by the use of sutures or filaments. The density of ePTFE is the ratio of the mass of a given sample of expanded PTFE to its volume. It determines the amount of void space and the microstructures of the material which allows nutrient diffusion across the membrane material and enhances tissue attachment to the micro porous surface.

Furthermore, ePTFE is an inert and biocompatible material with a history of medical implant use. U.S. Pat. Nos. 3,953,566, 4,187,390, 6,702,971 and 7,374,679 (the disclosures of which are incorporated herein by reference) teach methods for producing ePTFE and characterize its porous structure. The microstructure of ePTFE is a three-dimensional matrix of nodes connected by fibrils. The pore size of ePTFE can be characterized by determining the bubble point and the mean flow pressure of the material. Bubble point and mean flow pressure are measured according to the American Society for Testing and Materials Standard ASTM F316-03(2011) using alcoholic solution.

The fibril length of ePTFE is defined herein as the average length of fibrils between nodes connected by fibrils in the direction of expansion. PTFE expanded in one or more than one direction are thought to be equally applicable to the invention. The measurement of average fibril length and pore sizes are well known to those skilled in the art and are disclosed in references cited herein, including U.S. Pat. No. 5,032,445, and in ASTM F316-03(2011).

It is known to those skilled in the art that the microstructures of ePTFE depended on the processing conditions of the manufacturing process, in particularly the stretching ratio, the stretching rate and the amount of volatile components contained within the material. It is also known that there is no single parameter that can precisely characterize the microstructures of the ePTFE material due to the complex geometry of the node and fibril microstructures. Some lower density ePTFE, thus higher porosity, may have shorter average fibril length than higher density ePTFE, and vice versa. The measurement of average fibril length is well described in U.S. Pat. No. 5,032,445. The node and fibril structures could be present in a tortuous path fashion rather than straight vertically across the membrane. This also complicates the characterization of microstructures of micro porous ePTFE. In addition, certain processes produce asymmetrical ePTFE sheets, meaning the porosity of the surface layers is different from the bulk or the central portion of the ePTFE.

U.S. Pat. No. 5,032,445 teaches the use of macro porous ePTFE material with average fibril lengths greater than about 60 microns, preferably greater than about 100 microns, ethanol bubble points of less than about 2.0 psi, preferably less than about 0.75 psi, ethanol mean flow pressure less than about 10 psi, preferably less than about 3.0 psi, and densities less than about 1 g/cc and preferably about 0.3 to about 0.1 g/cc to enhance connective tissue ingrowth for use in guided tissue regeneration in the repair of bone defects. During wound hearing, tissue grows into and integrates with the porous material. While the tissue incorporation into the material stabilizes the wound site, it presents a difficult problem to the patient and the surgeon during the removal process. The incorporated cells and fibrous connective material may make removal of the barrier painful and traumatic to the patient, and it is very time consuming and difficult for the surgeon. In addition, the use of macro porous biomaterials in the oral cavity may result in early bacterial contamination of the material. Bacterial contamination of macro porous biomaterials may result in antibiotic-resistant infection, which can require early removal of the device.

U.S. Pat. No. 5,957,690 teaches the use of an unsintered, high density PTFE membrane with discrete, plural indentations of about 0.5 mm in width distributed uniformly throughout the surface of the material, and a density ranging from 1.2 g/cc to about 2.3 g/cc. Such unsintered, high density PTFE materials are essentially non-porous, and are featureless when examined by the use of scanning electron microscope even at micron level. While these materials successfully block off the ingrowth of tissue and contamination of bacteria, the risk of dehiscence and splitting of the gingival tissue overlying the membrane still exists due to limited surface attachment and poor diffusion of nutrients across the non-porous membranes. The discrete superficial macro indentations exhibit limited improvement in enhancing surface attachment. This invention provides a sheet of micro porous ePTFE membrane that exhibits micro surface texture, which is characterized by three-dimensional node and fibril microstructure as illustrated by U.S. Pat. No. 4,187,390, at a level relevant to and discernible by the creeping cells and tissue, but limits the deep penetration of bacteria and ingrowth of tissue into and across the membrane material. The micro porous ePTFE of the present invention allows nutrients to diffuse across the membrane to maintain the health of the thin tissue overlying the membrane, and in addition, to provide multi-fold increase in surface areas for tissue and cells to anchor and attach onto micro porous surface comparing with non-porous high density PTFE and macro porous ePTFE membranes. Bacteria colonization is blocked off by the combination of the small pore size and the low surface tension of the ePTFE material or compartmentalized in the highly hydrophobic micro pores and cannot multiply. The upper boundary of micro porous structures is limited by the deep ingrowths and integration of tissue within the material that will result in lengthy and traumatic removal of the ePTFE material, and/or the colonization of bacteria within the micro porous material that will cause infection and/or inflammation. The lower threshold of the micro porous structures is limited by the adequate diffusion of nutrients across the membranes to support the healthy growth and metabolism of the overlying tissue and cells.

The diffusion of nutrients across the membranes, such as glucose or body fluids, may be determined using diffusion chambers, wherein one chamber filled with nutrients dissolved in an simulated body fluid solution is separated by a barrier membrane from a neighboring chamber containing only simulated body fluid solution. The rate of diffusion of the nutrients across the membrane, if any, is determined by measuring the concentration of the nutrients diffusing into the neighboring chamber at different time durations. Bacteria penetration across the membrane, if any, may be determined using a similar method.

Preferably, the micro pores of ePTFE membrane will facilitate the tissue to adhere and attach to the surface without ingrowth deeper than one, two, to several cellular length, and support the healthy growth and metabolism of the tissue while the bone is regenerated under the membrane. More importantly, the micro pores of ePTFE membrane would develop biofilm on the surface of the ePTFE membrane and prevent bacteria from colonizing or penetrating across the barrier membrane to cause inflammation and/or infection. Also, the membrane will support the growth and attachment of the tissue without inflammation and/or infection caused by bacteria contamination or colonization, and yet still removable by non-surgical removal procedures.

Non-surgical removal procedures are defined as non-traumatic, and retrievable by the use of a forceps to grasp the membrane and pull off gently from the wound site after a small incision (for primary closed situation), or non-traumatic, and retrieved by the use of a curette to separate the adhered tissue from the material, then removed by the use of a forceps. For non-primary closed case, no incision is needed as a part of the membrane is exposed throughout the wound healing, and the membrane can be removed using the procedures described above without an incision.

Preferably, the average superficial fibril length of the micro porous ePTFE membrane of the present invention is selected from one of the following ranges: (A) from about 40 micron to 60 microns, (B) from about 30 microns to 40 microns, (C) from about 20 microns to 30 microns, (D) from about 10 microns to 20 microns, and (E) from about 0.1 microns to 15 microns. The density of the micro porous membrane is preferably selected from one of the following ranges: (A) from about 0.3 g/cc to 1.2 g/cc, (B) from about 0.3 g/cc to about 0.5 g/cc, (C) from about 0.5 g/cc to about 0.8 g/cc) and (D) from about 0.8 g/cc to about 1.1 g/cc. The bubble point pressure measured on the micro porous ePTFE membrane of the present invention is selected from one of the following ranges: (A) greater than 1.5 psi, (B) greater than 2.0 psi and (C) greater than 3.0 psi.

Depending upon clinical applications and requirements, the sheet of medical barrier of the present invention may have a thickness in a range of about 0.1 mm to about 3 mm, preferably in the range of about 0.10 mm to about 1.00 mm, and more preferably in the range of about 0.1 mm to about 0.3 mm. The textured surface comprises a continuous dotted pattern of specific features, including holes, and preferably a continuous woven pattern, a continuous mesh-like pattern, or a continuous pattern of hills and valleys formed on the surface of the sheet. If the sheet has only one textured surface, the valley or the indentations have a depth less than the thickness of the sheet and each valley or indentation has a width of less than 1.0 mm, and preferably less than 0.5 mm. The textured patterns are distributed substantially uniform over the surface of the sheet. If the sheet has textured pattern on both surfaces, the valley or the indentations have a depth less than the half the thickness of the sheet. The textured pattern is preferably repeated at less than 500 microns, preferably less than 200 microns and more preferably at less than 100 microns distributed uniformly over the surface of the sheet. Such woven, hills-and-valley or grooves patterns provides more surface areas at the macro level and are more conducive for tissue to anchor and attach than the pattern consisting of plurality of discrete indentations taught by the prior arts.

The barrier of the present invention is made by first forming a thin sheet of micro porous ePTFE and then embossing the sheet with a metal or plastic mesh. Manufacturing of ePTFE is well known to those skilled in the art. U.S. Pat. Nos. 3,953,566, 4,187,390, 6,7029,71 and 7,374,679 (the disclosures of which are incorporated herein by reference) teach methods for producing ePTFE and characterize its porous structure. An appropriate process is selected to make thin flat sheets of the desired thickness, a desired density and desired micro porous structures, including, average fibril length and bubble point pressure, and having substantially uniform strength in all directions. The resulting flat sheet has two substantially smooth surfaces. After the sheet is made and trimmed to the appropriate size, it is embossed to form a desired texture in one or both of its surfaces. In the preferred embodiment, the embossing step is performed by placing a sheet of patterned metal or polymer mesh on top of the unembossed sheet of ePTFE. The patterned metal or polymer sheet material, such as polyethylene or polypropylene, is harder and has more compressive strength than the micro porous ePTFE material. One of the preferred mesh is a fine pore-size titanium mesh manufactured by Unicare Biomedical, Inc. (California). The titanium mesh has a pattern that is embossed into the polymer sheet. The titanium mesh and the ePTFE sheet are passed together between a pair of rollers, which emboss the pattern of the titanium mesh into one or both surface of the ePTFE sheet. After embossing, the embossed ePTFE sheet may be cut into smaller sheets of various shape and size for packaging and distribution.

From the foregoing, it may be seen that the medical barrier of the present invention overcomes the shortcomings of the prior arts. In one embodiment, the present invention provides a micro porous ePTFE sheet that allows the attachment and ingrowth of cells and tissue onto the ePTFE sheet or into the ePTFE sheet within one, two, to several cell length in depth, but not across the sheet material, and the tissue can still be separated from the barrier membranes by gently pulling or peeling apart from the micro porous sheet with non-surgical and non-traumatic procedures. In another embodiment, the present invention due to the presence of three-dimensional node and fibril structure at the micron level provides a significantly more surface areas for attachment and anchoring to facilitate tissue attachment than conventional high density PTFE material and macro porous material. In still another embodiment, the present invention provides an ePTFE barrier membrane that exhibits surface texture both at the micro level with three-dimensional node and fibril structure, and at the macro level created by the embossing process, which is not envisioned by the prior arts. In still another embodiment, the present invention provides an ePTFE sheet with surface textures that can be tailored at the micro level by adjusting the micro porosity of the barrier and at the macro level by controlling the embossing process. Such flexibility and advantages accompanied with the features are not envisioned and disclosed by the prior arts.

Such micro porous ePTFE that facilitates cell and tissue attachment, but limits its penetration to one, two or just several cellular layer is particularly well adapted for use in medical applications that requires non-traumatic, non-surgical removal of the ePTFE membranes after wound healing or tissue regeneration is completed. This medical barrier of the present invention is particularly useful in guided tissue regeneration in the repair of bone defects, such as in the repair of alveolar bone defects. The barrier prevents rapidly migrating gingival tissue cells from entering the defect and allows the alveolar bone to regenerate. At the same time, the barrier allows the nutrients to diffuse through the barrier to maintain the healthy attachment, growth and metabolism of the gingival tissue. During healing, the gingival tissue adheres to the textured surface of the barrier to anchor the gingival tissue over the barrier, thereby preventing dehiscence or splitting open of the tissue covering the material. However, the pore sizes are limited to an extent that it prevents the gingival tissue from growing into and integrate with the barrier. Thus, after the bone defect has healed, the barrier may be removed with a minimum of trauma to the gingival tissue.

### EXAMPLE 1

### Making Textured ePTFE Membrane

A sheet of micro porous expanded PTFE membrane having a density of 0.8 g/cc, a thickness of 0.3 mm and an average fibril length of 3 microns made according to the prior arts disclosed above are used for the study. The ePTFE membranes were trimmed into appropriate width and sandwiched between two sheets of thin titanium mesh (Cytoflex® Mesh, by Unicare Biomedical, Inc.). The titanium mesh has a thickness of 0.004″, a hole diameter of 0.010″ and a hole edge-to-edge distance of 0.005″. The titanium mesh and the ePTFE sheet are passed together between a pair of rollers, which emboss the pattern of the titanium mesh into both surface of the micro porous ePTFE sheet. After embossing, the embossed ePTFE sheets are cut into a 25 mm×30 mm rectangular shape for packaging and sterilization by ethylene oxide.

### EXAMPLE 2

### Aging Study

20 pieces of ethylene oxide sterilized textured micro porous ePTFE membranes made in accordance with Example 1 are used in this study. The micro and marco surface textures of the membrane can be examined by microscope, such as a light microscope or scanning electron microscope at magnifications ranging from 10× to 200×. The 25×30 mm rectangular sheets are placed in an oven set at an elevated temperature to speed up the aging of the material. In accordance with Arrhenius Equation, every ten degree Celsius increase in temperature would double the speed of aging. After simulating up to 4 years of aging at room temperature, the stability of the texture pattern were examined and compared with a non-aged sample at 6× magnification. There were no significant differences in micro and macro surface textures between the aged and non-aged control samples.

### EXAMPLE 3

### Clinical Study

Five sterilized, surface textured micro porous ePTFE membranes prepared according to Example 1 were evaluated clinically by practitioners using a flapless, minimally invasive extraction and implant placement combined with guided bone regeneration. The barrier membrane was found readily attached by the surrounding tissue and there were no inflammation or infection due to the use of the barrier membranes. At the completion of the bone regeneration, the membranes were removed using non-traumatic procedures. The result of the study confirms that usefulness of the barrier membranes prepared according to the present invention.

What is claimed is:

1. A medical barrier comprising an expanded polytetrafluoroethylene (ePTFE) sheet having micro pores characterized by a three-dimensional matrix of nodes connected by fibrils, said medical barrier having at least one textured surface.

2. The medical barrier according to claim 1, wherein an average fibril length is selected from one of the following ranges: (A) from 1 micron to about 10 microns, (B) from about 10 microns to about 20 microns, (C) from about 20 microns to about 30 microns, (D) from about 30 microns to 40 microns, and (E) from about 40 microns to about 60 microns.

3. The medical barrier according to claim 1, wherein the density of the medical barrier is selected from one of the following ranges: (A) from about 0.3 g/cc to 1.2 g/cc, (B) from about 0.3 g/cc to about 0.5 g/cc, (C) from about 0.5 g/cc to about 0.8 g/cc), and (D) from about 0.8 g/cc to about 1.1 g/cc.

4. The medical barrier according to claim 1, wherein pattern of the textured surface does not fade over four years of aging at ambient temperature.

5. The medical barrier according to claim 1, wherein bubble point pressure measured on the micro porous ePTFE sheet is selected from one of the following ranges: (A) greater than 1.5 psi, (B) greater than 2.0 psi, and (C) greater than 3.0 psi.

6. The medical barrier according to claim 1, wherein the ePTFE sheet is configured to have macro texture created by an embossing process and micro texture created by the three-dimensional structure of nodes and fibrils to facilitate tissue adherence and attachment to the surface of the ePTFE sheet with limited tissue ingrowth, and support healthy growth and metabolism of the tissue while bone is regenerated under the sheet.

7. The medical barrier according to claim 1, wherein said ePTFE sheet is configured to allow nutrients to diffuse across the sheet to maintain tissue health overlying the sheet.

8. The medical barrier according to claim 1, wherein said ePTFE sheet is configured to block off bacteria colonization by the combination of small pore size and low surface tension of ePTFE material.

9. The medical barrier according to claim 6, wherein said ePTFE sheet is configured to be used in medical applications that requires non-traumatic, non-surgical removal of the ePTFE sheet after wound healing or tissue regeneration is completed.

10. The medical barrier according to claim 1, wherein said ePTFE sheet is used in guided tissue regeneration in the repair of bone defects.

11. The medical barrier according to claim 10, wherein said bone defect is alveolar bone defect.

12. The medical barrier according to claim 11, wherein said ePTFE sheet having micro pores is configured to prevents rapidly migrating gingival tissue cells from entering the defect and allows the alveolar bone to regenerate and heal under the ePTFE sheet.

13. A method of repairing a defect in alveolar bone underlying gingival tissue, which comprises steps of placing a sheet of textured, micro porous expanded polytetrafluoroethylene (ePTFE) membrane over said defect between the bone and the gingival tissue with said textured surface in contact with said gingival tissue; securing the gingival tissue over the membrane; allowing the defect to heal under the membrane; and removing the membrane after the defect has healed, wherein said the micro porous ePTFE membrane is allowed to be removed in a non-surgical procedures with the use of forceps and/or curette.

14. The method as claimed in claim 13, wherein said micro porous ePTFE membrane has an average fibril length selected from one of the following ranges: (A) from 1 micron to about 10 microns, (B) from about 10 microns to about 20 microns, (C) from about 20 microns to about 30 microns, (D) from about 30 microns to 40 microns, and (E) from about 40 microns to about 60 microns.

15. The method as claimed in claim 13, wherein density of the micro porous ePTFE membrane is selected from one of the following ranges: (A) from about 0.3 g/cc to 1.2 g/cc, (B) from about 0.3 g/cc to about 0.5 g/cc, (C) from about 0.5 g/cc to about 0.8 g/cc) and (D) from about 0.8 g/cc to about 1.1 g/cc.

16. The method as claimed in claim 13, wherein bubble point pressure measured on the micro porous ePTFE membrane is selected from one of the following ranges: (A) greater than 1.5 psi, (B) greater than 2.0 psi and (C) greater than 3.0 psi.

17. The method as claimed in claim 13, wherein the textured pattern is repeated at less than 100 microns distributed uniformly over a surface of the membrane.

18. The method as claimed in claim 13, wherein the ePTFE membrane is configured to have macro texture created by an embossing process and micro texture created by the three-dimensional structure of nodes and fibrils to facilitate said gingival tissue to adhere and attach to the ePTFE membrane with limited gingival tissue ingrowth, and support healthy growth and metabolism of the gingival tissue while said alveolar bone is regenerated under the membrane.

19. The method as claimed in claim 13, wherein pattern of the textured ePTFE surface does not fade over four years of aging at ambient temperature.
